(19) United States
(12) Patent Application Publication
(10) Pub. No.: US 2004/0144641 A1
(43) Pub. Date: Jul. 29, 2004

(54) Metal-based anodes for aluminum production cells

(76) Inventors: Vittorio De Nora, Nassau (BS); Thinh T. Nguyen, Onex (CH)

Correspondence Address: J R Desmukh, 6 Meetinghouse Ct, Princeton, NJ, 08540, US

(21) Appl. No.: 10/474,857

(22) PCT Filed: Apr. 10, 2002
(86) PCT No.: PCT/IB02/01169

(30) Foreign Application Priority Data
Apr. 12, 2001 (WO) PCT/IB01/00640

(51) Int. Cl. B23H 3/04

(52) U.S. Cl. 204/290.1

(57) ABSTRACT

An anode for use in a cell for the electrowinning of aluminum from alumina comprises a substrate with a core having an outer portion made of nickel covered with a barrier layer for inhibiting diffusion of fluoride species oxygen species to the core and preventing diffusion of constituents from the core during use. The barrier layer is made of silver and an electrochemically active noble metal miscible with nickel and silver, e.g. gold or palladium. The anode is coated with an electrochemically active surface layer which can be made of one or more cerium compounds.

### FIELD OF THE INVENTION

This invention relates to metal-based anodes for aluminium production cells, aluminium production cells operating with such anodes as well as operation of such cells to produce aluminium.

### BACKGROUND ART

The technology for the production of aluminium by the electrolysis of alumina, dissolved in molten cryolite, at temperatures around 950° C. is more than one hundred years old. This process, conceived almost simultaneously by Hall and Héroult, has not evolved as many other electrochemical processes.

The anodes are still made of carbonaceous material and must be replaced every few weeks. During electrolysis the oxygen which should evolve on the anode surface combines with the carbon to form polluting CO₂ and small amounts of CO and fluorine-containing dangerous gases. The actual consumption of the anode is as much as 450 Kg/Ton of aluminium produced which is more than ⅓ higher than the theoretical amount of 333 Kg/Ton.

Using metal anodes in aluminium electrowinning cells would drastically improve the aluminium process by reducing pollution and the cost of aluminium production.

U.S. Pat. No. 6,077,415 (Duruz/de Nora) discloses a metal-based anode comprising a metal-based core covered with a conductive oxygen barrier layer of chromium, niobium or nickel oxide and an electrochemically active outer layer, the barrier layer and the outer layer being separated by an intermediate layer to prevent dissolution of the oxygen barrier layer.

U.S. Pat. Nos. 4,614,569 (Duruz/Derivaz/Debely/Adorian), 4,680,094, 4,683,037 (both in the name of Duruz) and 4,966,674 (Bannochie/Sheriff) describe metal anodes for aluminium electrowinning coated with a protective coating of cerium oxyfluoride, formed in-situ in the cell or pre-applied, this coating being maintained by the addition of small amounts of cerium to the molten cryolite.

Along the same lines, EP Patent application 0 306 100 and U.S. Pat. Nos. 5,069,771, 4,960,494 and 4,956,068 (all in the name of Nyguen/Lazouni/Doan) disclose aluminium production anodes having an alloy substrate protected with an oxygen barrier layer, inter-alia containing platinum or another precious metal, that is covered with a copper-nickel layer for anchoring a cerium oxyfluoride operative surface coating.

Although the above mentioned prior art metal-based anodes showed a significantly improved lifetime over known oxide and cermet anodes, they have not as yet found commercial acceptance.

Also, it has been found that prior art metal anodes, in particular those operating with a cerium-based electrochemically active coating, are liable to corrode by exposure to fluorides present in the electrolyte.

### OBJECTS OF THE INVENTION

A major object of the invention is to provide an anode for aluminium electrowinning which has no carbon so as to eliminate carbon-generated pollution and increase the anode life.

An important object of the invention is to reduce the solubility of the surface of an aluminium electrowinning anode, thereby maintaining the anode dimensionally stable without excessively contaminating the product aluminium.

Another object of the invention is to provide a cell for the electrowinning of aluminium utilising metal-based anodes, and a method to produce aluminium in such a cell and preferably maintain the metal-based anodes dimensionally stable.

A main object of the invention is to provide a metal-based anode for the production of aluminium which is resistant to fluoride and oxygen attack.

### SUMMARY OF THE INVENTION

Therefore, the invention relates to a metal-based anode substrate for an electrochemically active coating and for use in a cell for the electrowinning of aluminium from alumina dissolved in a fluoride-containing molten electrolyte. The substrate comprises a core having an outer portion made of nickel covered with a barrier layer for inhibiting diffusion of fluoride species and oxygen species to the core and preventing diffusion of constituents from the core during use. According to the invention, this barrier layer is made of silver and one or more electrochemically active noble metals miscible with nickel and silver.

As mentioned above, it has been observed that prior art aluminium production metal-based anodes are attacked during use by fluorides. Also when aluminium production cells are operated with an electrolyte at reduced temperature, i.e. below 960° C., fluoride attack increases, as the fluoride content is higher.

Without being bound to any theory, it is believed that metal oxides present at the surface of metal-based anodes, like oxides of iron, nickel, copper, chromium etc. . . . , combine during use with fluorides of the electrolyte to produce soluble oxyfluorides.

The invention is based on the observation that silver can be used as a barrier layer to fluoride attack. At high temperature, i.e. above 450° C., silver does not form an oxide and remains as a metal. It follows from the above theory that during use fluorides cannot form oxyfluorides by exposure to the silver layer which is devoid of oxide, and the fluorides cannot corrode the silver layer.

Furthermore, it has been found that the adherence of a silver layer on nickel can be improved by using a noble metal, such as palladium or gold, which alloys with silver and which is miscible nickel. The presence of such a noble metal in the silver-based layer also permits oxygen evolution thereon, inhibits diffusion of oxygen therethrough and increases its melting point above the temperature of operation in conventional cryolite-based melts, i.e. above 950°-970° C., making it suitable for use in cells operating with an electrolyte at conventional temperature or at reduced temperature, e.g. from 830° to 930° C.

An electrochemically active layer made of one or more cerium compounds can be deposited in-situ directly onto the silver-noble metal barrier layer.

Alternatively, an electrochemically active layer suitable for the anode substrate can also be made of another active anode material, as for example disclosed in U.S. Pat. Nos. 6,077,415 (Duruz/de Nora), 6,103,090 (de Nora) and 6,248,227 (de Nora/Duruz), and PCT publications WO99/36591 (de Nora), WO99/36593 (de Nora/Duruz), WO00/06803 (Duruz/de Nora/Crottaz), WO00/06804 (Crottaz/ Duruz), WO00/40783 (de Nora/Duruz), WO01/42534 (de Nora/ Duruz), WO01/42535 (Duruz/de Nora) and WO01/42536 (Duruz/ Nguyen/de Nora).

The barrier layer of the anode substrate can be formed by applying first a layer of the noble metal(s) on the core and then a layer of silver on the noble metal(s) followed by thermal interdiffusion of the noble metal(s) and silver before use or in-situ, or by application of a layer of an alloy of silver and the noble metal(s).

Suitable noble metal(s) can be selected from palladium, gold, rhodium, osmium and iridium and mixtures thereof.

Usually, the barrier layer comprises 80 to 99 weight % silver, the balance being the noble metal(s).

The barrier layer may have a thickness in the range of 20 to 200 micron.

The anode substrate can further comprise a layer of copper metal and/or oxides on the barrier layer. The copper layer usually has a thickness in the range of 10 to 50 micron. Such a copper layer is particular suitable to serve as a nucleation and anchorage layer for an electrochemically active layer of one or more cerium compounds which can be deposited thereon before or during use.

The core may comprise an integral surface film of conductive nickel oxide, such as non-stoichiometric and/or doped nickel oxide. Usually, such a nickel oxide film is formed by heat treatment of the core and the barrier layer before and/or during use in an oxidising media and results from limited diffusion of oxygen through the barrier layer. The nickel oxide film reinforces the effect of the barrier layer and prevents oxygen diffusion into the core. Furthermore, the formation of the nickel oxide film at the surface of the core stops the interdiffusion between nickel from the core and the noble metal(s) from the barrier layer.

The invention also relates to an anode for a cell for the electrowinning of aluminium from alumina dissolved in a fluoride-containing molten electrolyte. The anode comprises an anode substrate as described above covered with an electrochemically active coating.

The electrochemically active coating may be made of one or more cerium compounds, for instance comprising cerium oxyfluoride. Further details of such coatings can be found in the above mentioned U.S. Pat. Nos. 4,614,569, 4,680,094, 4,683,037 and 4,966,674.

Alternatively, the electrochemically active coating can be made of another active material, as for example disclosed in the references mentioned above.

Another aspect of the invention relates to a cell for the electrowinning of aluminium from alumina dissolved in a fluoride-based molten electrolyte. The cell comprises at least one metal-based anode as described above.

As mentioned above, the electrochemically active coating of the anode(s) can be made of one or more cerium compounds, in which case the electrolyte preferably comprises cerium species to maintain the electrochemically active surface coating.

The electrolyte can be at a reduced temperature, e.g. in the range from 830° to 930° C. However, the cell may also be operated with an electrolyte at conventional temperature, i.e. about 950 to 970° C., in which case the electrochemically active coating is advantageously made of one or more cerium compounds to avoid excessive contamination of the product aluminium with anode materials.

A further aspect of the invention relates to a method of producing aluminium in a cell as described above. The method comprises dissolving alumina in the electrolyte and passing an electrolysis current between the or each anode and a facing cathode whereby oxygen is anodically evolved and aluminium is cathodically produced.

### DETAILED DESCRIPTION OF THE INVENTION

The invention will be further described in the following Examples:

### EXAMPLE 1

Anode Substrate Preparation:

An anode substrate according to the invention was prepared by coating a nickel core successively with a layer of palladium having a thickness of 10 micron, a layer of silver having a thickness of 60 micron and a layer of copper having a thickness of 35 micron for anchoring a cerium oxyfluoride layer on the anode substrate.

The layer of palladium was electrodeposited on the nickel core from an electrolytic bath containing Pd(NH₃)₄(N0₃)₂ and NH₄OH. The layer of silver was electrodeposited on the palladium layer from an electrolytic bath containing AgCN and KCN. The layer of copper was electrodeposited on the silver from an electrolytic bath containing CuSO₄ and H₂SO₄.

The coated nickel core was then heat treated at about 900° C. for 4 hours in order to oxidise the copper layer and interdiffuse the palladium layer with the silver layer on one side and with nickel from the core on the other side to form a silver-palladium alloy layer strongly anchored on the core. Due to the limited permeability to oxygen of the silver-based layer, a thin conductive nickel oxide layer was formed on the nickel core which inhibited further diffusion of oxygen into the core.

Testing in a Fluoride-Based Electrolyte:

The anode substrate was covered in-situ with a cerium oxyfluoride electrochemically active layer to form an anode and tested for several hours.

The anode substrate was pre-heated over a molten electrolyte in a laboratory scale cell. The molten electrolyte consisted of about 21 weight % AlF₃, 6 weight % Al₂O₃, 3 weight % CeF₃ and 72 weight % Na₃AlF₆ at a temperature of about 920° C. The cell used an aluminium pool as a cathode.

Then the anode substrate was immersed in the electrolyte. At the beginning of electrolysis, to permit formation of an electrochemically active cerium oxyfluoride coating on the anode substrate, a reduced electrolysis current was passed between the anode substrate and the aluminium cathodic pool at an anodic current density of about 0.5 A/cm². After 5 hours the current density was increased to about 0.8 A/cm².

To compensate depletion of CeF₃ and Al₂O₃ during electrolysis, the cell was periodically supplied with a powder feed of Al₂O₃ containing 1 weight % CeF₃. The feeding rate corresponded to 50% of the cathodic current efficiency. After 24 hours the anode was removed from the molten bath and cooled down to room temperature.

The cell voltage was stable at 4.1-4.2 volt during the entire test.

Examination After Testing:

Visual examination of the anode showed that a blue and uniform cerium oxyfluoride coating had been deposited on the part of the anode substrate that had been immersed in the cryolite-based electrolyte.

The anode was cut perpendicular to a cerium oxyfluoride coated surface and the section was examined under a SEM microscope.

It was observed that the cerium-based coating had a thickness of about 500 to 700 micron. Underneath the cerium-based coating, the copper oxide had a thickness of about 40-45 micron. The silver-palladium layer had remained un-oxidised. The anode core showed no sign of corrosion or exposure to fluorides.

### EXAMPLE 2

Another anode substrate according to the invention was prepared and tested as in Example 1.

The anode substrate consisted of a nickel core with a silver-palladium layer. The silver palladium layer was formed on the substrate by deposition of a palladium layer and a silver layer followed by heat treatment at about 900° C. as in Example 1 (i.e. omitting the copper layer of Example 1).

The anode substrate was pre-heated and then immersed in a fluoride-based electrolyte containing cerium species for the formation of a cerium oxyfluoride coating thereon and tested as in Example 1.

After 24 hours the anode was removed from the molten bath and cooled down to room temperature.

Visual examination of the anode showed that a blue cerium oxyfluoride coating had been deposited on the part of the anode substrate that had been immersed in the cryolite-based electrolyte. The cerium oxyfluoride coating was not as uniform as in Example 1.

The anode was cut perpendicular to a cerium oxyfluoride coated surface and the section was examined under a SEM microscope. It was observed that the ceriumbased coating had a thickness of about 500 to 700 micron. Underneath the cerium-based coating the silver-palladium layer had remained un-oxidised. The anode core showed no sign of corrosion or exposure to fluorides.

The present test demonstrated that the silver-palladium barrier layer can act as an anchorage layer for in-situ deposition of a cerium oxyfluoride coating.

### EXAMPLE 3

Examples 1 and 2 were repeated using a silver-gold barrier layer instead of a silver-palladium layer.

The silver-gold barrier layer had a thickness of 60 micron and was obtained by electrolytic co-deposition on the nickel core of silver and gold from a bath containing AgCN-KAu(CN)₂ and KCN. The silver-gold layer had a gold content of 10 weight %.

Anode substrates with a silver-gold barrier layer were coated with a cerium oxyfluoride coating and tested as in Examples 1 and 2 and led to similar test results.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications and variations which fall within the spirit and broad scope of the appended claims.

Whereas the above anode substrates were tested with cerium oxyfluoride electrochemically active layers, other electrochemically active layers may be used, for instance those mentioned above.

1. A metal-based anode substrate for an electrochemically active coating and for use in a cell for the electrowinning of aluminium from alumina dissolved in a fluoride-containing molten electrolyte, said substrate comprising a core having an outer portion made of nickel covered with a barrier layer for inhibiting diffusion of fluoride species and oxygen species to the core and preventing diffusion of constituents from the core during use, wherein the barrier layer is made of silver and one or more electrochemically active noble metals miscible with nickel and silver.

2. The anode substrate of claim 1, wherein the barrier layer comprises an outer portion made of silver and an inner portion made of the noble metal(s).

3. The anode substrate of claim 1, wherein the barrier layer is made of an alloy of silver and the noble metal(s).

4. The anode substrate of any preceding claim, wherein the noble metal(s) is/are selected from palladium, gold, rhodium and iridium and mixtures thereof.

5. The anode substrate of any preceding claim, wherein the barrier layer comprises 80 to 99 weight % silver, the balance being the noble metal(s).

6. The anode substrate of any preceding claim, wherein the barrier layer has a thickness in the range of 20 to 200 micron.

7. The anode substrate of any preceding claim, which further comprises a layer of copper metal and/or oxides on the barrier layer.

8. The anode substrate of claim 7, wherein the copper layer has a thickness in the range of 10 to 50 micron.

9. The anode substrate of any preceding claim, wherein the core comprises an integral surface film of conductive nickel oxide.

10. An anode for a cell for the electrowinning of aluminium from alumina dissolved in a fluoride-containing molten electrolyte, said anode comprising an anode substrate as defined in any preceding claim covered with an electrochemically active coating.

11. The anode of claim 10, wherein the electrochemically active coating is made of one or more cerium compounds.

12. The anode of claim 11, wherein the electrochemically active coating comprises cerium oxyfluoride.

13. A cell for the electrowinning of aluminium from alumina dissolved in a fluoride-based molten electrolyte, comprising at least one metal-based anode according to claim 10, 11 or 12.

14. The cell of claim 13, wherein the electrochemically active coating of the anode(s) is made of one or more cerium compounds, the electrolyte comprising cerium species to maintain the electrochemically active surface coating.

15. The cell of claim 13 or 14, wherein the electrolyte is at a temperature in the range from 830° to 930° C.

16. A method of producing aluminium in a cell as defined in any one of claims 13 to 15, comprising dissolving alumina in the electrolyte and passing an electrolysis current between the or each anode and a facing cathode whereby oxygen is anodically evolved and aluminium is cathodically produced.
